(19) United States
(12) Patent Application Publication
(10) Pub. No.: US 2011/0103320 A1
(43) Pub. Date: May 5, 2011

(54) CONTENTION-BASED DATA COMMUNICATION APPARATUS AND METHOD

(75) Inventors: Sung-jin YOU, Daejeon (KR); Gwangzeen Ko, Daejeon (KR); Sung-Hyun Hwang, Daejeon (KR); Jung Sun Um, Daejeon (KR); Myung Sun Song, Daejeon (KR); Chang-Joo Kim, Daejeon (KR)

(73) Assignee: ELECTRONICS AND TELECOMMUNICATIONS RESEARCH INSTITUTE, Daejeon (KR)

(21) Appl. No.: 12/836,113

(22) Filed: Jul. 14, 2010

(30) Foreign Application Priority Data
Oct. 29, 2009 (KR) 10-2009-0103468
Feb. 12, 2010 (KR) 10-2010-0013324

(51) Int. Cl. H04W 72/04; H04L 12/413

(52) U.S. Cl. 370/329; 370/445

(57) ABSTRACT

Provided is a contention-based data communication apparatus and method that may notify that a radio resource is to be used using a search signal prior to transmitting a communication frame, and may transmit data based on a priority when a search signal received from another communication apparatus is detected.

### CROSS-REFERENCE TO RELATED APPLICATIONS

This application claims the benefit of Korean Patent Application No. 10-2009-0103468, filed on October 29, 2009, and Korean Patent Application No. 10-2010-0013324, filed on Feb. 12, 2010, in the Korean Intellectual Property Office, the disclosures of which are incorporated herein by reference.

### BACKGROUND

1. Field of the Invention

The present invention relates to a contention-based data communication apparatus and method, and more particularly, to a communication apparatus and method that may decrease a collision probability occurring due to multiple accesses.

2. Description of the Related Art

In general, a Carrier Sensing Media Access (CSMA) scheme has been used to decrease a collision in a contention-based communication apparatus. However, even though the CSMA scheme is used, a collision may occur when at least two different communication apparatuses simultaneously attempt transmission. A representative scheme corresponding to the collision may include a Collision Detection (CD) scheme and a Collision Avoidance (CA) scheme. The CD scheme indicates a scheme that may detect an occurrence of a collision when the collision occurs, and thereby suspend a data transmission and decrease a collision probability in a subsequent attempt using a random backoff. The CA scheme indicates a scheme that may use a random backoff prior to transmitting data and thereby decrease a collision probability. A representative system using a CSMA/CD scheme may include an Ethernet system defined in an Institute of Electrical and Electronics Engineers (IEEE) 802.3 standard. A representative system using a CSMA/CA scheme may include a wireless local area network (LAN) defined in an IEEE 802.11 standard.

### SUMMARY

An aspect of the present invention provides a contention-based data communication apparatus and method.

Another aspect of the present invention also provides a contention-based data communication apparatus and method that may notify that a radio resource is to be used using a search signal prior to transmitting data, and may transmit the data when a search signal received from another communication apparatus is not detected.

Another aspect of the present invention also provides a contention-based data communication apparatus and method that may notify that a radio resource is to be used using a search signal prior to transmitting data, and may transmit the data based on a priority, when a search signal received from another communication apparatus is detected. According to an aspect of the present invention, there is provided an apparatus for contention-based data communication, including: a search signal generator to generate a search signal having a priority; a search signal detector to detect a search signal received from another communication apparatus; and a transmission decision unit to transmit the search signal generated by the search signal generator when a radio resource is available, and to determine whether to transmit a communication frame, depending on whether the search signal received from the other communication apparatus exists, or a priority between the search signal received from the other communication apparatus and the transmitted search signal.

According to another aspect of the present invention, there is provided a method for contention-based data communication, including: transmitting a search signal having a transmission intent when a radio resource is available; determining whether to transmit a communication frame depending on whether a search signal received from another communication apparatus exists, or a priority between the search signal received from the other communication apparatus and the transmitted search signal; and transmitting the communication frame when the communication frame is determined to be transmitted. According to still another aspect of the present invention, there is provided a method for contention-based data communication, including: transmitting a search signal having a transmission intent when a radio resource is available; determining whether to transmit a communication frame depending on whether a search signal received from another communication apparatus exists, or a priority between the search signal received from the to other communication apparatus and the transmitted search signal; standing by for a random backoff when the transmission is determined to be transmitted; and transmitting the communication frame when the radio resource is available after the random backoff.

According to yet another aspect of the present invention, there is provided a method for contention-based data communication, including: standing by for a random backoff when a radio resource is available; transmitting a search signal having a transmission intent when a radio resource is available after the random backoff; determining whether to transmit a communication frame depending on whether a search signal received from another communication apparatus exists, or a priority between the search signal received from the other communication apparatus and the transmitted search signal; and transmitting the communication frame when the radio resource is available after the random backoff.

According to embodiments of the present invention, there may be provided a contention-based communication apparatus and method that may notify that a radio resource is to be used using a search signal prior to transmitting data, and thereby transmit the data based on a priority, when a search signal received from another communication apparatus is detected. Since a collision probability may be effectively reduced using the search signal, it is possible to decrease a resource waste caused by the collision.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a configuration of a contention-based data communication apparatus according to an embodiment of the present invention;

FIG. 2 is a diagram illustrating an example of generating a search signal using a frequency division scheme according to an embodiment of the present invention;

FIG. 3 is a diagram illustrating an example of generating a search signal using a time division scheme according to an embodiment of the present invention;

FIG. 4 is a diagram illustrating an operation of transmitting, by communication apparatuses, a communication frame based on a contention according to an embodiment of the present invention;

FIG. 5 is a diagram illustrating an operation of transmitting, by communication apparatuses using a time-divided search signal, a communication frame based on a contention according to an embodiment of the present invention;

FIG. 6 is a diagram illustrating an operation of transmitting, by communication apparatuses using a time-divided search signal, a communication frame based on a contention according to another embodiment of the present invention;

FIG. 7 is a flowchart illustrating a process for contention-based data communication according to an embodiment of the present invention;

FIG. 8 is a flowchart illustrating a process for contention-based data communication according to another embodiment of the present invention; and

FIG. 9 is a flowchart illustrating a process for contention-based data communication according to still another embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

According to embodiments of the present invention, there may be provided a contention-based communication apparatus and method that may notify that a radio resource is to be used using a search signal prior to transmitting data, and thereby transmit the data based on a priority, when a search signal received from another communication apparatus is detected.

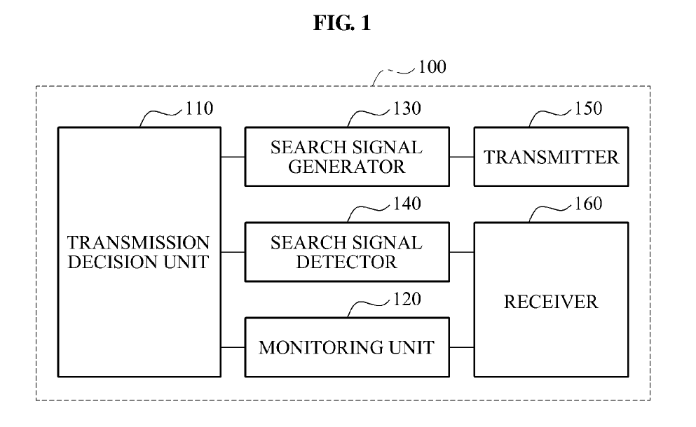

FIG. 1 is a block diagram illustrating a configuration of a contention-based data communication apparatus according to an embodiment of the present invention. Referring to FIG. 1, the contention-based data communication apparatus 100 may include a transmission decision unit 110, a monitoring unit 120, a search signal generator 130, a search signal detector 140, a transmitter 150, and a receiver 160.

The monitoring unit 120 may use the existence of a carrier received via the receiver 160. When the received carrier does not exist, the monitoring unit 120 may determine a radio resource is available.

The search signal generator 130 may generate a search signal having a priority. Here, that the search signal has the priority may indicate that the search signal has a transmission intent. The search signal generator 130 may generate the search signal to randomly allocate the priority, or may generate the search signal to allocate the priority according to a predetermined criterion. When the search signal is regenerated due to a defeat in an immediately previous contention, the search signal generator 130 may generate a search signal having a relatively high priority compared to an immediately previously generated search signal.

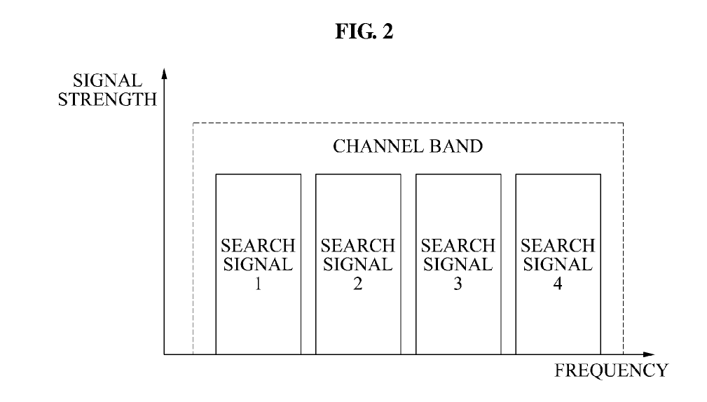

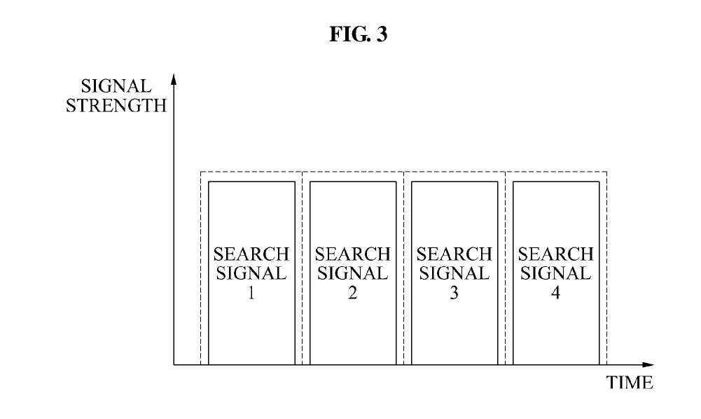

The search signal generator 130 may generate the search signal using a frequency division scheme as shown in FIG. 2, and may also generate the search signal using a time division scheme as shown in FIG. 3. Also, the search signal generator 130 may generate the search signal using a code division scheme.

FIG. 2 is a diagram illustrating an example of generating a search signal using a frequency division scheme according to an embodiment of the present invention, and FIG. 3 is a diagram illustrating an example of generating a search signal using a time division scheme according to an embodiment of the present invention.

The search signal generator 130 may generate the search signal by combining at least two of the frequency division scheme, the code division scheme, and the time division scheme.

The search signal detector 140 may detect a search signal received from another communication apparatus via the receiver 160.

When the radio resource is available as a verification result using the monitoring unit 120, the transmission decision unit 110 may transmit, via the transmitter 150, the search signal generated by the search signal generator 130. Depending on whether the search signal received from the other communication apparatus exists, or a priority between the search signal received from the other communication apparatus and the transmitted search signal, the transmission decision unit 110 may determine whether to transmit a communication frame.

Initially, the transmission decision unit 110 may transmit the search signal. When the search signal received from the other communication apparatus via the receiver 160 does not exist, the transmission decision unit 110 may control the communication frame to be transmitted.

When the search signal received from the other communication apparatus via the receiver 160 exists, the transmission decision unit 110 may verify the priority between the transmitted search signal and the received search signal, and may control the communication frame to be transmitted when the priority of the transmitted search signal is higher than the priority of the received search signal.

In this instance, the transmission decision unit 110 may verify the priority between the transmitted search signal and the received search signal based on a frequency magnitude or a transmitted and received time within a search interval of transmitting and receiving the search signal. Specifically, the transmission decision unit 110 may prefer a search signal to having a relatively great frequency magnitude, and may also prefer a search signal received last within the search interval.

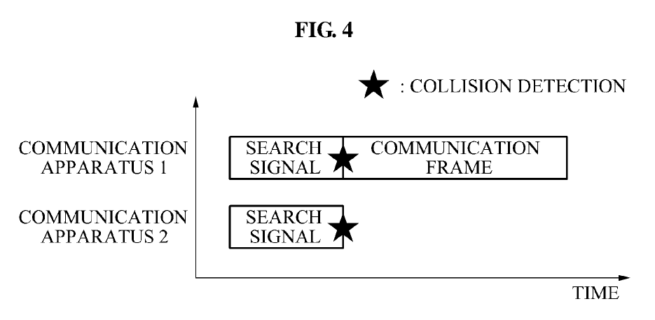

FIG. 4 is a diagram illustrating an operation of transmitting, by communication apparatuses 1 and 2, a communication frame based on a contention according to an embodiment of the present invention. Referring to FIG. 4, the communication apparatuses 1 and 2 may transmit a search signal indicating that the search signal has a transmission intent, prior to transmitting the communication frame, to detect a collision. In this instance, search signals may need to be transmitted using different frequencies to detect the collision, as shown in FIG. 2.

Each of the communication apparatuses 1 and 2 may detect the received search signal. Each of the communication apparatuses 1 and 2 may compare a priority of the transmitted search signal and a priority of the received signal, and thereby determine whether to transmit the communication frame. For example, with assumption that a communication apparatus transmitting a search signal of a high frequency has a priority, when a frequency of a search signal of the communication apparatus 1 is higher than a frequency of a search signal of the communication apparatus 2, the communication apparatus 2 receives the high frequency of the search signal compared to the frequency of the search signal of the communication apparatus 2 and thus may suspend a transmission. Since a search signal of a higher frequency than the frequency of the search signal of the communication apparatus 1 does not exist, the communication apparatus 1 may continuously perform transmission.

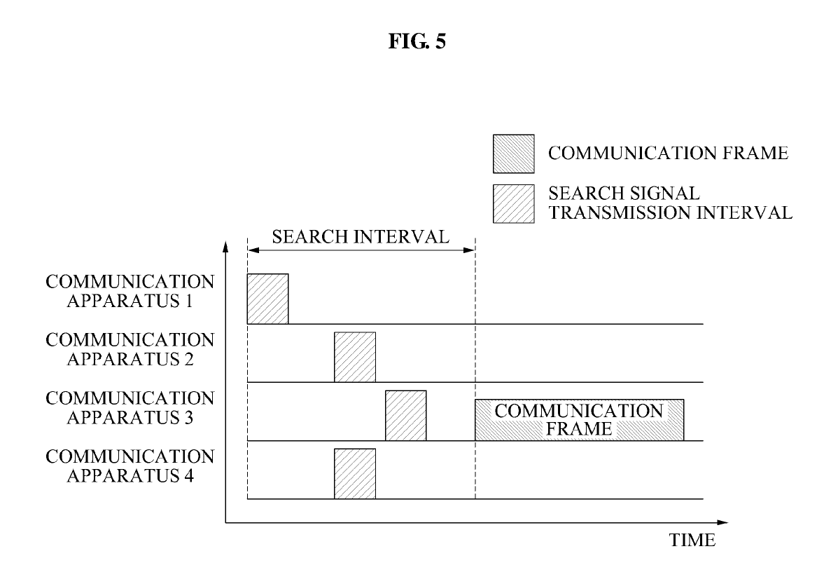

FIG. 5 is a diagram illustrating an operation of transmitting, by communication apparatuses 1, 2, 3, and 4 using a time-divided search signal, a communication frame based on a contention according to an embodiment of the present invention. Referring to FIG. 5, when the communication frame exists, each of the communication apparatuses 1, 2, 3, and 4 may transmit a search signal having a transmission intent within a search interval prior to transmission for a collision detection. to In this instance, the search signal is generated according to a time division scheme.

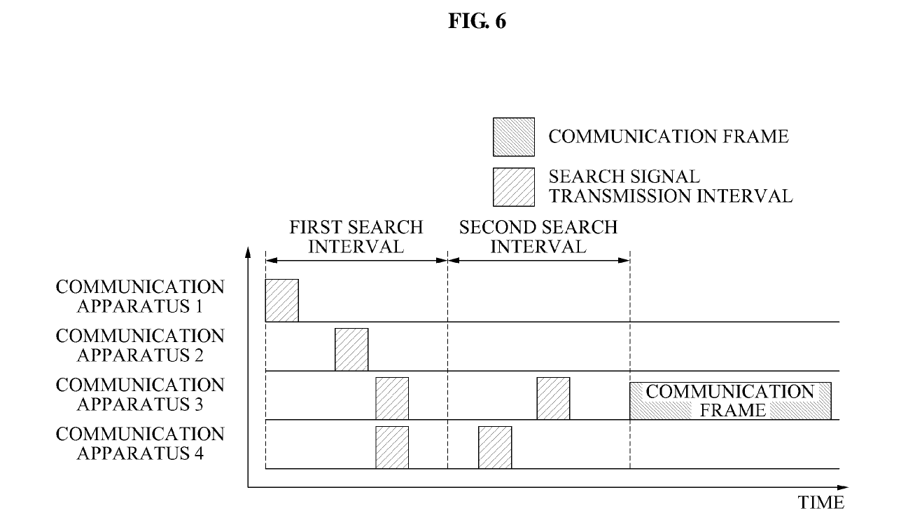

A search signal received last within the search interval is set to have a highest priority. Accordingly, in FIG. 5, the search signal of the communication apparatus 3 is received last and thus has the highest priority. Accordingly, the communication apparatus 3 may transmit the communication frame. FIG. 6 is a diagram illustrating an operation of transmitting, by communication apparatuses 1, 2, 3, and 4 using a time-divided search signal, a communication frame based on a contention according to another embodiment of the present invention.

A search scheme of FIG. 6 is similar to the search scheme of FIG. 5. In FIG. 6, the communication apparatuses 3 and 4 having a search signal with a highest priority within a first search interval exist and thus a priority between the communication apparatuses 3 and 4 may be verified using a second search interval. In the second search interval, the search signal of the communication apparatus 3 arrives later than the search signal of the communication apparatus 4. Thus, the communication apparatus 3 having the highest priority may transmit the communication frame. As shown in FIG. 6, when search signals collide with each other, it is possible to solve the collision between the search signals by repeating the search interval of transmitting the search signals.

When the communication apparatuses 1 and 2 happen to transmit the same frequency of the search signal in FIG. 4, the communication apparatuses 1 and 2 may not identify each other's existence whereby both of the communication apparatuses 1 and 2 may transmit the communication frame. This case is referred to as a search failure. The transmission decision unit 110 may decrease a collision probability by adding a random backoff in preparation for the search failure.

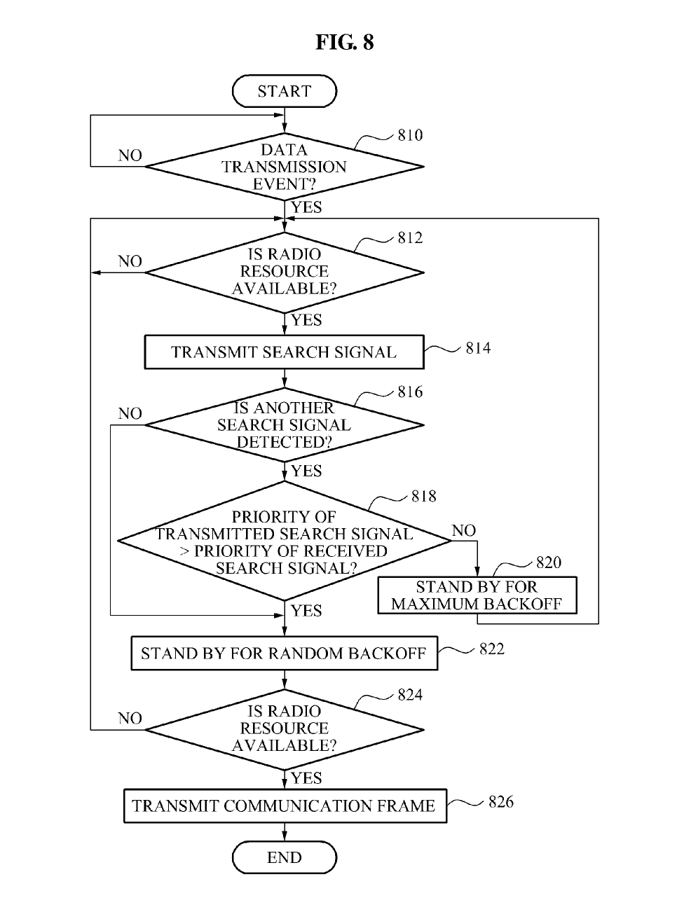

The transmission decision unit 110 may stand by for the random backoff prior to transmitting the communication frame, and may verify again whether the radio resource is available. When the radio resource is available, the transmission decision unit 110 may control the communication frame to be transmitted. A scheme of standing by for the random backoff prior to transmitting the communication frame will be further described with reference to FIG. 8.

The transmission decision unit 110 may stand by for the random backoff prior to transmitting the search signal, and may verify again whether the radio resource is available.

When the radio resource is available, the transmission decision unit 110 may control the search signal to be transmitted. A scheme of standing by for the random backoff prior to transmitting the search signal will be further described with reference to FIG. 8.

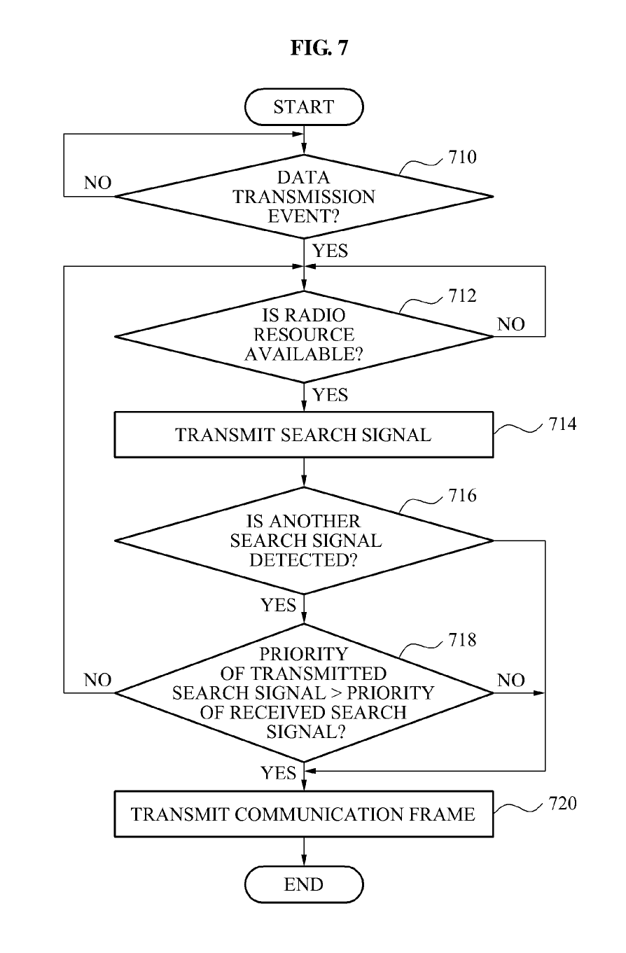

FIG. 7 is a flowchart illustrating a process for contention-based data communication according to an embodiment of the present invention. Referring to FIG. 7, when a data transmission event indicating that data to be transmitted exists is detected in operation 710, a communication apparatus may verify whether a radio resource is available in operation 712. When a received carrier does not exist, the communication apparatus may determine the radio resource is available.

When the radio resource is available in operation 712, the communication apparatus may select and transmit a search signal having a transmission intent in operation 714. In operation 716, the communication apparatus may verify whether a search signal received from another communication apparatus is detected.

When the search signal received from the other communication apparatus is detected in operation 716, the communication apparatus may verify a priority between the transmitted search signal and the received search signal to thereby verify whether the priority of the transmitted search signal is higher than the priority of the received search signal in operation 718.

When the received search signal has a higher priority than the transmitted search signal in operation 718, the communication apparatus may return to operation 712 and repeat operations 712 through 718.

When the search signal received from the other communication apparatus is not detected in operation 716, or when the priority of the transmitted search signal is higher in operation 718, the communication apparatus may secure the radio resource and transmit a communication frame in operation 720. FIG. 8 is a flowchart illustrating a process for contention-based data communication according to another embodiment of the present invention. Referring to FIG. 8, when a data transmission event indicating that data to be transmitted exists is detected in operation 810, a communication apparatus may verify whether a radio resource is available in operation 812. When a received carrier does not exist, the communication apparatus may determine the radio resource is available.

When the radio resource is available in operation 812, the communication apparatus may select and transmit a search signal having a transmission intent in operation 814. In operation 816, the communication apparatus may verify whether a search signal received from another communication apparatus is detected. When the search signal received from the other communication apparatus is detected in operation 816, the communication apparatus may verify a priority between the transmitted search signal and the received search signal to thereby verify whether the priority of the transmitted search signal is higher than the priority of the received search signal in operation 818.

When the received search signal has a higher priority than the transmitted search signal in operation 818, the communication apparatus may stand by for a predetermined backoff in operation 820, and then return to operation 812 to repeat operations 812 through 818. The predetermined backoff may be a maximum value settable as backoff.

When the search signal received from the other communication apparatus is not detected in operation 816, or when the priority of the transmitted search signal is higher than the priority of the received search signal in operation 818, the communication apparatus may stand by for a random backoff in operation 822. In operation 824, the communication apparatus may verify again whether the radio resource is available.

When the radio resource is unavailable in operation 824, the communication apparatus may return to operation 812 to repeat operations 812 through 824. Conversely, when the radio resource is available, the communication apparatus may secure the radio resource and transmit a communication apparatus in operation 826.

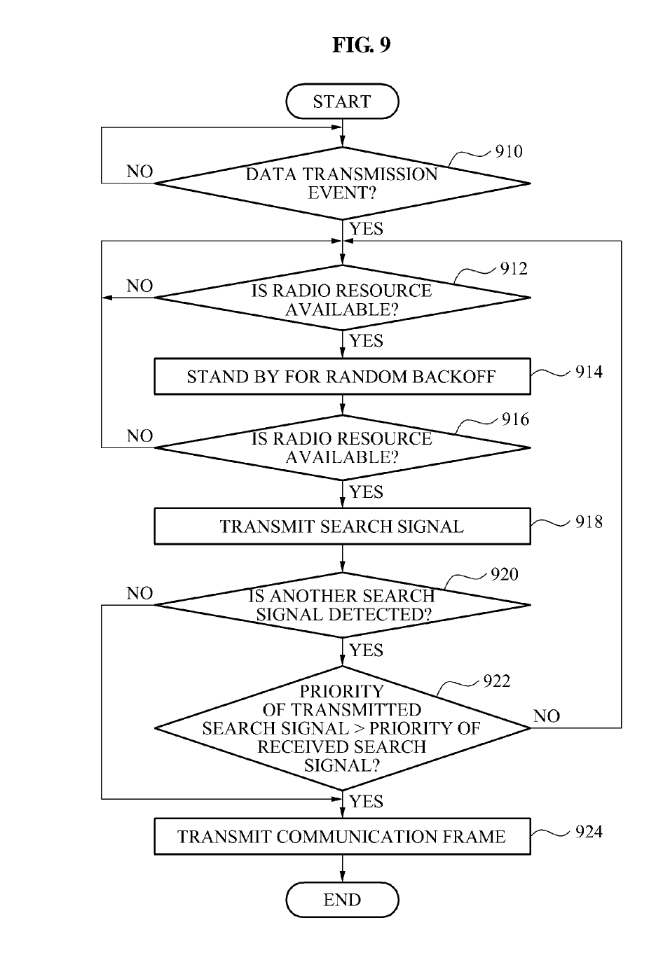

FIG. 9 is a flowchart illustrating a process for contention-based data communication according to still another embodiment of the present invention. Referring to FIG. 9, when a data transmission event indicating that data to be transmitted exists is detected in operation 910, a communication apparatus may verify whether a radio resource is available in operation 912. When a received carrier does not exist, the communication apparatus may determine the radio resource is available.

When the radio resource is available in operation 912, the communication apparatus may stand by for a random backoff in operation 914, and may verify again whether the radio resource is available in operation 916.

When the radio resource is unavailable in operation 916, the communication apparatus may return to operation 912 and repeat operations 912 through 916.

When the radio resource is available in operation 916, the communication apparatus may select and transmit a search signal having a transmission intent in operation 918. In operation 920, the communication apparatus may verify whether a search signal received from another communication apparatus is detected.

When the search signal received from the other communication apparatus is detected in operation 920, the communication apparatus may verify a priority between the transmitted search signal and the received search signal to thereby verify whether a priority of the transmitted search signal is higher than the priority of the received search signal in operation to 922.

When the received search signal has a higher priority than the transmitted search signal in operation 922, the communication apparatus may return to operation 912 and repeat operations 912 through 918.

When the search signal received from the other communication apparatus is not detected in operation 920, or when the priority of the transmitted search signal is higher in operation 922, the communication apparatus may secure the radio resource and transmit a communication frame in operation 924.

The contention-based data communication method according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the to scope of which is defined by the claims and their equivalents.

What is claimed is:

1. An apparatus for contention-based data communication, comprising:
a search signal generator to generate a search signal having a priority;
a search signal detector to detect a search signal received from another communication apparatus; and
a transmission decision unit to transmit the search signal generated by the search signal generator when a radio resource is available, and to determine whether to transmit a communication frame, depending on whether the search signal received from the other communication apparatus exists, or a priority between the search signal received from the to other communication apparatus and the transmitted search signal.

2. The apparatus of claim 1, wherein the search signal generator generates the search signal based on at least one of a frequency division scheme, a code division scheme, and a time division scheme.

3. The apparatus of claim 1, wherein the search signal generator generates the search signal to randomly allocate the priority, or generates the search signal to allocate the priority according to a predetermined criterion.

4. The apparatus of claim 1, wherein in the case of a defeat in an immediate previous contention, the search signal generator generates a search signal having a relatively high priority compared to an immediately previously generated search signal.

5. The apparatus of claim 1, wherein when the priority of the transmitted search signal is verified to be higher than the priority of the received search signal, or when the received search signal does not exist, the transmission decision unit determines the communication frame is to be transmitted.

6. The apparatus of claim 5, wherein the transmission decision unit verifies the priority by comparing at least one of a transmitted and received time, and a frequency magnitude between the transmitted search signal and the received search signal.

7. The apparatus of claim 1, wherein the transmission decision unit stands by for a random backoff prior to transmitting the communication frame, and transmits the communication frame when the radio resource is available.

8. The apparatus of claim 1, wherein the transmission decision unit stands by for a random backoff prior to transmitting the search signal.

9. A method for contention-based data communication, comprising:
transmitting a search signal having a transmission intent when a radio resource is available;
determining whether to transmit a communication frame depending on whether a search signal received from another communication apparatus exists, or a priority between the search signal received from the other communication apparatus and the transmitted search signal; and
transmitting the communication frame when the communication frame is determined to be transmitted.

10. The method of claim 9, wherein the search signal generator generates the search signal based on at least one of a frequency division scheme, a code division scheme, and a time division scheme.

11. The method of claim 9, wherein the determining comprises determining the communication frame is to be transmitted when the priority of the transmitted search signal is verified to be higher than the priority of the received search signal, or when the received search signal does not exist.

12. The method of claim 11, wherein the determining comprises verifying the priority by comparing at least one of a transmitted and received time, and a frequency magnitude between the transmitted search signal and the received search signal.

13. The method of claim 9, wherein the transmitting of the search signal comprises randomly selecting and transmitting the search signal to randomly allocate the priority, or selecting and transmitting the search signal to allocate the search signal according to a predetermined criterion

14. The method of claim 9, wherein the transmitting of the search signal comprises transmitting a search signal having a relatively high priority compared to an immediately previously transmitted search signal in the case of a defeat in an immediate previous contention.

15. A method for contention-based data communication, comprising:
transmitting a search signal having a transmission intent when a radio resource is available;
determining whether to transmit a communication frame depending on whether a search signal received from another communication apparatus exists, or a priority between the search signal received from the other communication apparatus and the transmitted search signal;
standing by for a random backoff when the transmission is determined to be transmitted; and
transmitting the communication frame when the radio resource is available after the random backoff.

16. The method of claim 15, wherein the determining comprises determining the communication frame is to be transmitted when the priority of the transmitted search signal is verified to be higher than the priority of the received search signal, or when the received search signal does not exist.

17. The method of claim 16, further comprising:
standing by for a predetermined backoff, when the received signal having a relatively high priority compared to the transmitted search signal exists.

18. A method for contention-based data communication, comprising:
standing by for a random backoff when a radio resource is available;
transmitting a search signal having a transmission intent when a radio resource is available after the random backoff;
determining whether to transmit a communication frame depending on whether a search signal received from another communication apparatus exists, or a priority between the search signal received from the other communication apparatus and the transmitted search signal; and
transmitting the communication frame when the radio resource is available after the random backoff.

19. The method of claim 18, wherein the determining comprises determining the communication frame is to be transmitted when the priority of the transmitted search signal is verified to be higher than the priority of the received search signal, or when the received search signal does not exist.

20. The method of claim 18, wherein the transmitting of the search signal comprises randomly selecting and transmitting the search signal to randomly allocate the priority, or selecting and transmitting the search signal to allocate the search signal according to a predetermined criterion
